(19) United States
(12) Patent Application Publication
(10) Pub. No.: US 2018/0320428 A1
(43) Pub. Date: Nov. 8, 2018

(54) HINGE

(71) Applicant: Cotswold Architectural Products Limited, Cheltenham Gloucestershire (GB)

(72) Inventor: Neal Desorgher, Gloucestershire (GB)

(21) Appl. No.: 15/773,547

(22) PCT Filed: Nov. 4, 2016
(86) PCT No.: PCT/GB2016/053452

§ 371 Date: May 3, 2018

(30) Foreign Application Priority Data
Nov. 4, 2015 (GB) 1519468.1

(51) Int. Cl. E05D 15/34; E05D 15/46

(52) U.S. Cl. CPC E05D 15/34; E05Y 2900/148; E05D 15/46

(57) ABSTRACT

A parallel hinge (10) for holding an opening member in a frame. The hinge (10) includes a first arm (11) connected between a fixed pivot (16) mountable on one of the member and frame and a movable pivot (17) mountable on the other of member and frame. The hinge (10) includes a second arm (12) connected between a fixed pivot (18) mountable on the other of the member and frame and a movable pivot (19) mountable on the one of the member and frame. The arms (11, 12) being pivotally connected (13) intermediate their ends to allow a scissor action. One of the arms (12) has two portions (14, 15) such that one portion lies above the other arm at the intermediate pivot and the other portion lies below, such that on closing the arms can overlie one another. Each of the portions (14, 15) of the arm (12) has a first end mountable on one of the member and frame, and a second opposed end providing a load transfer member (22, 23) extending beyond the intermediate pivot (13). The load transfer member (22, 23) of each portion is engaged with the other portion in order to distribute the load uniformly across at least a portion of the arm (12).

This invention relates to a parallel hinge for holding an opening member, for example a window, in a frame. As is usual in this field, the term parallel hinge indicates one in which the opening member moves out of the frame in a manner in which it is maintained generally parallel to its closed position.

Known parallel hinges (which may alternatively be referred to as “parallel stays”) typically include a pair of arms pivoted together at their centres to form a scissor-like structure, each arm having one end connected to one of the frame or opening member and the other end connected to the other of the frame or opening member. Typically one end of each arm is fixed and the other is movable. The connections on the frame or the member are usually formed on a single track, with the movable connection being in the form of a slider, which can move along the track, bearing a pivot.

Parallel hinges can be used in a vertical or horizontal orientation. If one considers them in the horizontal orientation (which for convenience will be used herein in a non-limiting manner), then it will be understood that one arm passes over the other, but each arm has a connection to each track. Known parallel hinges of this type generally include a hinged connection between the two arms at a central point to removes problem of interference.

In order to allow full closure of the parallel hinge one type of parallel hinge utilises an arrangement in which one of the two arms is formed of two separate portions connected at the central hinge. This provides an advantage of ensuring that the hinge can fully close by one portion of the arm being above the other arm and the other portion being below the arm. As such in the closed position the tracks for the frame and window may directly overlie one another in the closed position. This provides a more compact hinge in the closed position and may, for example, allow the hinge to be used in a smaller casement. Parallel hinges of this type are, for example, commercially available from the Applicant, Cotswold Architectural Products of Cheltenham, England.

According to an aspect the present invention there is provided a parallel hinge for holding an opening member in a frame, including a first arm connected between a fixed pivot mountable on one of the member and the frame and a movable pivot mountable on the other of the member and the frame, and a second arm connected between a fixed pivot mountable on the other of the member and the frame and a movable pivot mountable on the one of the member and the frame, the arms being pivotally connected intermediate their ends to allow a scissor action, wherein one of the arms has two discrete portions such that one portion lies above the other arm at the intermediate pivot and the other portion lies below, such that on closing the arms can overlie one another; characterised in that at least one of the portions of the arm comprises a load transfer arrangement which extends beyond the intermediate pivot to engage the other portion so as to provide a load transfer path which bypasses the intermediate pivot.

The applicants have recognised that a disadvantage of arrangements having an arm which is formed of two portions is that loading on the opening must transfer between the two portions via the intermediate pivot. This results in undesirable stress concentrations at the intermediate pivot. Embodiments of the invention may reduce or remove the stress concentration by transferring load directly from on portion of the arm to the other portion. Embodiments may therefore maintain the advantage of a fully closing mechanism whilst reducing the disadvantageous in strength of utilising an arm formed of two separate portions.

It will be understood that the terms “above” and “below” refer to the parallel hinge being in a horizontal orientation, although in use the hinge may have any appropriate orientation.

One load transfer member may lie above the other arm at the intermediate pivot and the other load transfer member lie below. As such, on closing the load transfer members may overlie one another.

The portions of the arm may each have a first end mountable on one of the pivots on the member and frame. The second opposed end of the portions of the arm may each have, the load transfer arrangement comprising a load transfer member at the second end. The load transfer member may extend beyond the intermediate pivot. Thus, the load transfer arrangement may comprise a load transfer member.

The hinge may further comprise at least one engagement feature to provide mutual engagement between the load transfer member and an adjacent section of the other portion of the arm. The mutual engagement feature may for example comprise a tab. The tab may for example extend substantially perpendicular to the longitudinal axis of the arm. It will be appreciated that other engagement features could for example include a protrusion, hook, tab, L-shaped member, recess, groove or slot or any combination thereof.

The adjacent section of the other portion of the arm may be provided with at least one second engagement feature for cooperative engagement with the at least one first engagement feature. For example, the second engagement feature comprises a recess in the side of the arm. The recess may be configured to receive a tab provided on the other arm portion.

Each of the portions of the arm may comprise a load transfer arrangement which extends beyond the intermediate pivot to engage the other portion of the arm. The load transfer arrangements of each portion of the arm may be arranged to engage on opposing sides of the arm. Providing a load transfer arrangement on each side of the arm, each of which are extending beyond the pivot, provides an arrangement which will transfer loads favourably between the portions so as to provide a more uniform stress distribution.

Each portion of the arm may provides at least one first engagement feature located on a load transfer member and at least one second engagement feature for cooperative engagement with the at least one first engagement feature provided by the load transfer member of the other portion of the arm. The at least one first engagement feature and at least one second engagement feature of a portion of the arm are located equidistant of the intermediate pivot. It will be appreciated that the location and longitudinal extent of the load transfer arrangement will directly influence the resulting load distribution (and can be tailored accordingly when designing a particular hinge).

The parallel hinge may be moveable between an open configuration in which the arms are arranged to hold the opening member in a position away from the frame, and a closed configuration in which the arms are arranged to hold the opening member in position adjacent the frame.

The transverse cross-sectional dimension of one or both portions of the arm, as measured within the plane of the direction of movement of the arms during opening of the hinge and/or opening member, preferably tapers inwardly towards the free end of the second end of the portion(s). For example, the transverse cross-sectional dimension of the load transfer member(s) tapers inwardly towards the free end of the second end of the portion(s).

The transverse cross-sectional dimension of the second end of one or both portion of the arm, as measured within the plane of the direction of movement of the arms during opening of the hinge and/or opening member, may taper inwardly from the at least one second engagement feature towards the at least one first engagement feature.

The intermediate pivot is may for example be located at the centre of each arm.

The arms may be cranked such that for each arm the ends lie in a single plane.

Although the invention has been defined above, it is to be understood that it includes any inventive combination of the features set out above or in the following description.

The invention may be performed in various ways and a specific embodiment will now be described with reference to the accompanying drawings, in which;

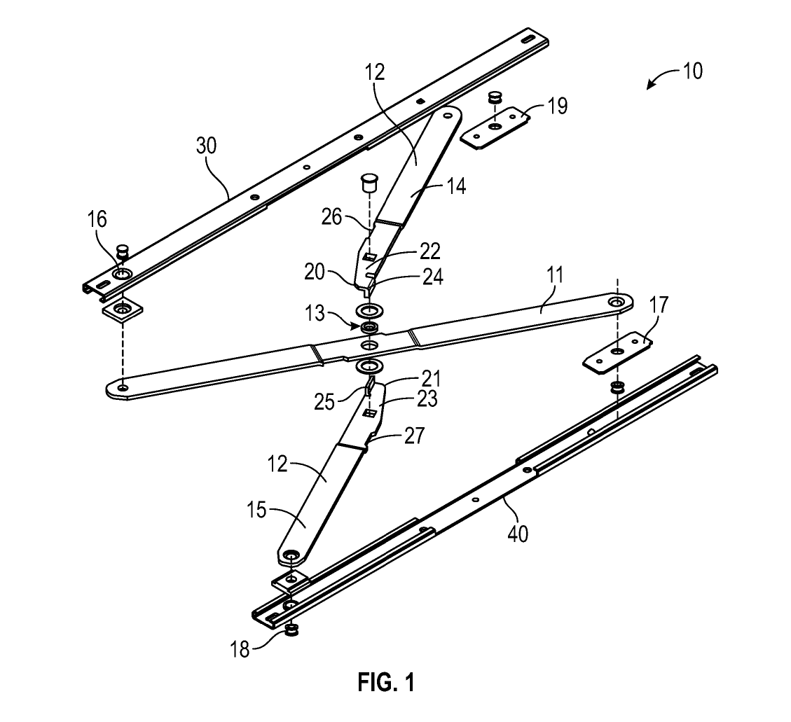

FIG. 1 is an exploded perspective view of a hinge according to an embodiment;

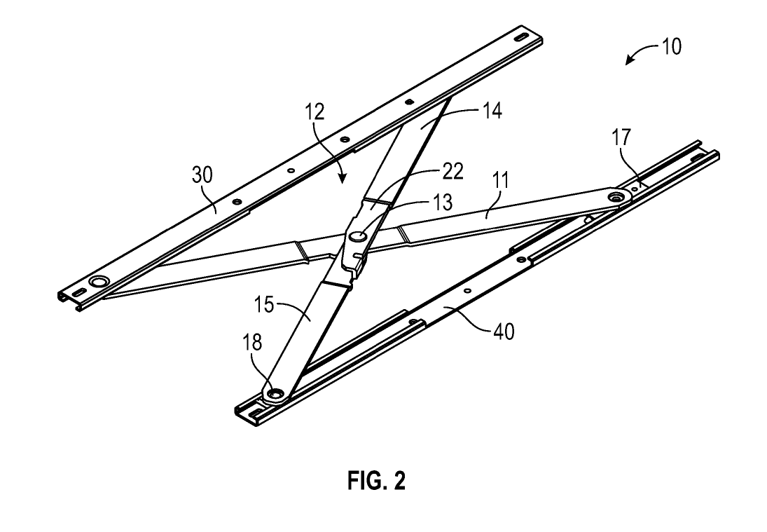

FIG. 2 is a plan view of an assembled hinge in its open position;

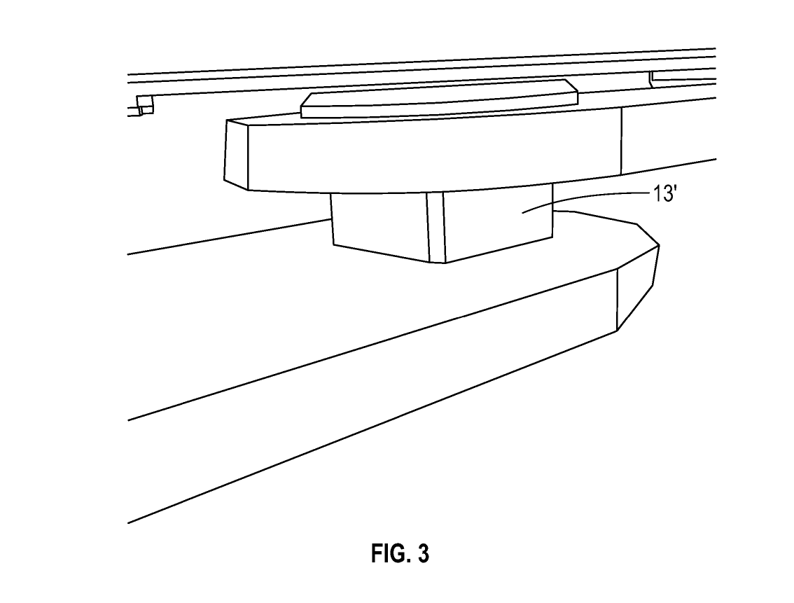

FIG. 3 is a schematic representation of the load distribution experienced across the pivot connection of a prior art parallel hinge arrangement; and

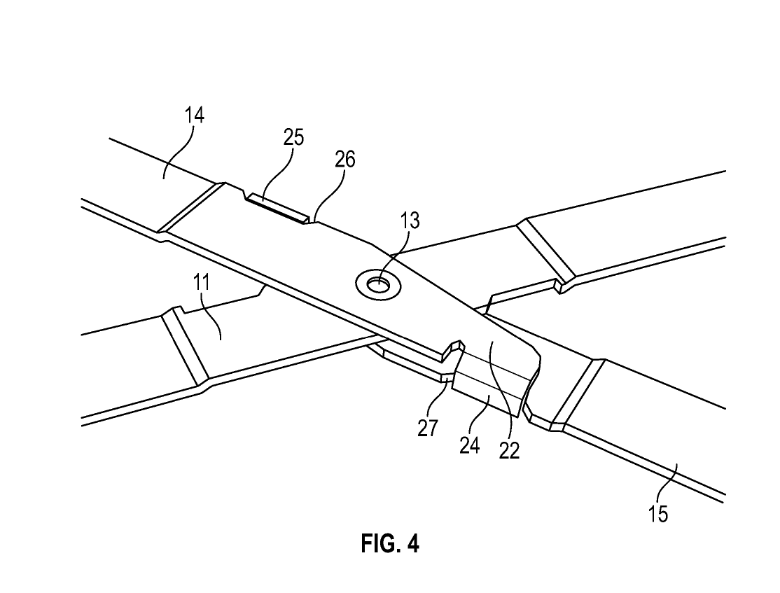

FIG. 4 is a schematic representation of the load distribution experienced across the pivot connection of the hinge of the present invention.

With reference to FIGS. 1 and 2, a hinge 10 according to an embodiment of the present invention, includes arms 11, 12 which are connected in a crossed manner between first and second parallel tracks 30, 40. The arms 11, 12 are inter-connected by a pivot connection 13 (which could be provided by a rivet) passing through their centres. The arms 11, 12 can be moved together and apart in a scissor-like action. For reasons that will be explained below in more detail, the arm 12 is split into portions 14, 15, which respectively lie above and below the arm 11.

The arm 11 is connected between a fixed pivot 16 on the first track 30 and a sliding or movable pivot 17 on the second track. Correspondingly, the arm 12 extends between a fixed pivot 18 on the second track 40 and a slideable pivot 19 on the first track 30. In use one of the tracks 30 and 40 will be attached to one of an opening member or frame (not illustrated), and the other track 40, 30 will be connected to the other of the window and frame.

As mentioned above, the portions 14, 15 of arm 12 respectively lie above and below the arm 11. In the closed position, the arms 11, 12 are in line with one another. Further, by suitably cranking the arms 11 and 12, the respective ends of the arms can be located in a single horizontal (in this orientation) plane in alignment with the relevant track 30, 40. As a result in the closed position, the pivots 16 and 18, and 19 and 17, are effectively stacked on top of one another. This means that the opening member can be fully and tightly closed within the frame, providing both increased security and a particularly pleasing aesthetic arrangement.

Arm 12 is split into two portions 14 and 15. A first end of one portion 15 is secured to one track 40 by a fixed pivot 18. The first end of the other portion 14 is secured to the other track 30 by a slideable pivot 19. The other adjacent ends 20, 21 of each portion 14, 15 are formed with a load transfer arrangement which provides an interconnection between the portions 14 and 15. The load transfer arrangement does not provide a fully rigid connection between the portions so does not remove the advantages of the multi-part construction but also enables load to be transferred between the portions by means other than the pivot 13. The load transfer arrangement may include a load transfer member 22, 23 at the second opposed ends 20, 21 of each of the portions 14, 15.

The load transfer member 22 of portion 14 extends beyond the intermediate pivot 13 and lies above the other arm 11. The other load transfer member 23 of portion 15 extends beyond the pivot 13 in the opposite direction and lies below arm 11. The load transfer members 22, 23 are each tapered inwardly towards the free end 20, 21 of the second end of the portions 14, 15.

Each load transfer member 22, 23 includes a tab 24, 25 at the second ends 20, 21 of the portion 14, 15. Each tab 24, 25 extends substantially perpendicular to the plane of the corresponding arm 11, 12. Each tab 24, 25 extends in a direction towards the other arm of the hinge. The tabs 24, 25 may be conveniently formed by a lateral extension from the arm portion which is then bent perpendicular to the plane of the arm. It may be noted that a transverse notch is cut in the arm portion next to the tab to assist in forming the tab.

Each portion 14, 15 of the arm 12 further provides a recess 26, 27 shaped and dimensioned to receive and engage the corresponding tab 24, 25 of the load transfer member 22,23 of the other portion 15, 14 of the arm 12. The tab 24, 25 and the recess 26, 27 are located equidistant of the intermediate pivot. The location of the tabs 24, 25 and recesses 26, 27 of the load transfer members 22, 23 ensure that the load is distributed evenly across the pivot connection 13.

Although the illustrated embodiment comprises a combination of tabs and recesses to provide cooperative engagement between the load transfer members 22, 23 and the other portion of arm 12, it is to be understood that the portions may comprise a combination of any suitable engagement features to provide cooperative engagement between the load transfer member of one portion and the other portion of the arm.

In the illustrated embodiment, the free ends 20, 21 of the portions 14, 15 of the arm 12 provide a tab 24, 25 for engagement with the other portion 15,14 of arm 12. It is however to be understood that the engagement feature 24, 25 may be provided at any suitable location on the load transfer member 22, 23 and are not required to be provided at the free end 20,21 of the corresponding portion 14, 15. The location of each of the engagement feature(s) on the portion of the arm will be determined by the distance over which the load is to be uniformly distributed across the arm.

FIGS. 3 and 4 show finite element modelling of the hinge under load. As shown in FIG. 3, when placed under a load, the prior art hinge 10′ experiences high and localised stresses concentrated at the pivot connection 13′. The highest strain being found in the rivet forming the pivot and in the portions of the arm immediately adjacent the pivot. As a result, such high and localised stresses could reduce the lifespan of the hinge 10′ and could result in early failure of the hinge 10′.

In contrast, FIG. 4 illustrates the load distribution across the pivot connection of the hinge 10 of the present invention. It can be seen that there are very minimal localised stress concentrations and that the stress has been distributed evenly across the pivot connection. In particular, it can be noted that the load transfer members 22, 23 of the hinge 10 spread the stresses across a greater portion of the intermediate connection with no high stress concentration found in the pivot 13. As a result, there is a reduced risk of early failure of the hinge of the present invention.

Although the invention has been described above with reference to a preferred embodiment, it will be appreciated that various changes or modifications may be made without departing from the scope of the invention as defined in the appended claims. For example, whilst the hinge described above has a single pair of arms the skilled person will appreciate that for some heavy duty applications multiple pairs of arms may be used. For example a pair of tracks may be supported by two pairs of scissor arms which act in parallel.

1. A parallel hinge for holding an opening member in a frame, the hinge comprising
a first arm connected between a fixed pivot mountable on one of the member and frame and a movable pivot mountable on the other of member and frame, and
a second arm connected between a fixed pivot mountable on the other of the member and frame and a movable pivot mountable on the one of the member and frame,
the arms being pivotally connected intermediate their ends to allow a scissor action, wherein one of the arms has two portions with one portion connected above the other arm at the intermediate pivot and the other portion connected below, such that on closing the arms can overlie one another;
characterised in that at least one of the portions of the arm comprises a load transfer arrangement which extends beyond the intermediate pivot to engage the other portion of the arm so at to provide a load transfer path which bypasses the intermediate pivot.

2. A hinge as claimed in claim 1, wherein the portions of the arm has a first end mountable on one of the pivots on the member and frame, and an second opposed end, the load transfer arrangement comprising a load transfer member at the second end which extends beyond the intermediate pivot.

3. A hinge as claimed in claim 2, further comprising at least one engagement feature to provide mutual engagement between the load transfer member and an adjacent section of the other portion of the arm.

4. A hinge as claimed in claim 3, wherein the mutual engagement feature comprises a tab extending substantially perpendicular to the longitudinal axis of the arm.

5. A hinge as claimed in claim 3, wherein the adjacent section of the other portion of the arm is provided with at least one second engagement feature for cooperative engagement with the at least one first engagement feature.

6. A hinge as claimed in claim 5, wherein the second engagement feature comprises a recess in the side of the arm.

7. A hinge as claimed in claim 1, wherein each of the portions of the arm comprise a load transfer arrangement which extends beyond the intermediate pivot to engage the other portion of the arm.

8. A hinge as claimed in claim 7, wherein the load transfer arrangements of each portion of the arm are arranged to engage on opposing sides of the arm.

9. A hinge as claimed in claim 7, wherein each portion of the arm provides at least one first engagement feature located on a load transfer member and at least one second engagement feature for cooperative engagement with the at least one first engagement feature provided by the load transfer member of the other portion of the arm.

10. A hinge as claimed in claim 9, wherein the at least one first engagement feature and at least one second engagement feature of a portion of the arm are located equidistant of the intermediate pivot.

11. A hinge as claimed in claim 1, wherein the transverse cross-sectional dimension of the second end of one or both portions of the arm tapers inwardly towards the free end of the second end of the portion.

12. A hinge as claimed in claim 1, wherein the intermediate pivot is located at the centre of each arm.

13. A hinge as claimed in claim 1, wherein the arms are cranked such that for each arm the ends lie in a single plane.

14. (canceled)
